(19) United States
(12) Patent Application Publication
(10) Pub. No.: US 2024/0092271 A1
(43) Pub. Date: Mar. 21, 2024

(54) MOUNTING HINGE MOUNTED ONTO COVERING SHELF OR CARGO SCREEN FOR VEHICLES

(71) Applicant: DAEHAN SOLUTION CO., LTD, Incheon (KR)

(72) Inventors: Choong HO KWON, Seoul (KR); Kang-Hee JO, Incheon (KR)

(73) Assignee: DAEHAN SOLUTION CO., LTD, Incheon (KR)

(21) Appl. No.: 18/238,657

(22) Filed: Aug. 28, 2023

(30) Foreign Application Priority Data
Sep. 21, 2022 (KR) 10-2022-0118999

(51) Int. Cl. B60R 5/04; E05D 7/00

(52) U.S. Cl. CPC B60R 5/044; E05D 7/0009

(57) ABSTRACT

The present invention provides a mounting hinge mounted on a covering shelf or cargo screen for vehicles, capable of maintaining an assembled state in which a hinge protrusion, which is elastically supported in a main body, is always in contact with a guide groove by configuring one side of the hinge protrusion to protrude out of the main body and configuring a protruding portion to be forcibly fitted into a guide groove formed in a trunk to assemble the covering shelf or cargo screen, thereby preventing detachment and separation of the covering shelf or cargo screen so that the covering shelf or cargo screen is safely and conveniently used. In this case, the present invention provides the mounting hinge mounted on a covering shelf or cargo screen for vehicles, capable of being stably, easily, and conveniently assembled/disassembled as the hinge protrusion moves according to a shape of a guide groove on a center line of rotation of the covering shelf or cargo screen because the hinge protrusion protrudes outward from the edge of the covering shelf or cargo screen.

### CROSS-REFERENCE TO RELATED APPLICATION

This application claims priority to and the benefit of Korean Patent Application No. 10-2022-0118999, filed on Sep. 21, 2022, the disclosure of which is incorporated herein by reference in its entirety.

### BACKGROUND

### 1. Field of the Invention

The present invention relates to a mounting hinge mounted onto a covering shelf or cargo screen for vehicles, and more particularly, to a mounting hinge mounted onto a covering shelf or cargo screen for vehicles, capable of not only making sure the covering shelf or the cargo screen is precisely positioned in a mounting position when the covering shelf or the cargo screen is mounted on a trunk so that the covering shelf or the cargo screen is safely used, but also preventing the covering shelf or cargo screen from being unintentionally removed from the mounting position, by configuring a hinge protrusion to expand and contract in a longitudinal direction by elastic support.

### 2. Discussion of Related Art

In general, as shown in FIGS. 1 to 3, in a vehicle in which a trunk T is opened and closed in the form of a hatchback, in order to increase the utilization of a trunk space and improve the aesthetic appearance and beauty, a covering shelf C or a cargo screen is used as disclosed in Korean Patent Registration No. 10-1875600 (registered on Jul. 2, 2018), Korean Patent Registration No. 10-1875701 (registered on Jul. 2, 2018), and Korean Patent Registration No. 10-2411825 (registered on Jun. 17, 2022) below. Here, the covering shelf is a kind of shelf that rotates together when the trunk is opened so that there is no inconvenience in using the trunk, and as necessary, is used to put light items thereon. In addition, the cargo screen refers to a product manufactured to cover an item by being spread out in the form of a screen on the item when the item is stored in the trunk.

Korean Patent Registration No. 10-1875600 discloses a covering shelf mounting device for vehicles capable of preventing distortion of a covering shelf due to noise generated at a wire connecting part and a difference between upper support parts of wires as compared to a method of interlocking with opening and closing of a tailgate through a wire by allowing the covering shelf to be used by being switched to a horizontally mounted state or an inclined mounted state at the same hinge point and making it possible to implement solid fixation of a position in each state. The aforementioned covering shelf mounting device for vehicles includes left and right luggage trims installed in a luggage room of a vehicle body, a covering shelf pivotably installed between the luggage trims, and a hinge structure that connects the covering shelf to the luggage trims in a switchable state, respectively, in the inclined mounted state or the horizontally mounted state, and the hinge structure includes a hinge shaft provided on the luggage trim and having a hooking protrusion on an outer circumferential surface, a hinge bracket provided on the covering shelf for hinge coupling with the hinge shaft, and an elastic restraining unit installed on the hinge bracket to limit a turning angle of the hooking protrusion to an inclined state or a horizontal state, respectively.

Korean Patent Registration No. 10-1875701 discloses a covering shelf mounting device for vehicles capable of preventing distortion of a covering shelf due to noise generated at a wire connecting part and a difference between upper support parts of wires as compared to a method of interlocking with opening and closing of a tailgate through a wire by allowing the covering shelf to be used by being switched to a horizontally mounted state or an inclined mounted state. The aforementioned covering shelf mounting device for vehicles includes left and right luggage trims installed in a luggage room, the covering shelf pivotably installed between the luggage trims, a hinge pin assembly installed on the covering shelf to pivotably fix the covering shelf, a hinge groove provided in the luggage trims for coupling with the hinge pin assembly, a sliding pin assembly installed on the luggage trim to fix the covering shelf in an inclined state, a mounting groove provided in the covering shelf for coupling with the sliding pin assembly, and a raised support portion provided on the luggage trim and supporting the covering shelf in a horizontally mounted state.

Korean Patent Registration No. 10-2411825 discloses a cargo screen mounted in a luggage room or the like of a vehicle. According to the configuration, a cargo screen for vehicles including a screen unit that forms a predetermined plane to shield a luggage room, is partially or wholly made of a flexible material, and has a visually identifiable identification unit provided on one side thereof, and a wire unit that extends along an edge of the screen unit and maintains a shape of the screen unit may be provided. Such a cargo screen for vehicles may be implemented with a flexible and lightweight material, and upper and lower surfaces may be easily distinguished through the identification unit.

In particular, as shown in FIGS. 3 to 5, such a covering shelf C and cargo screen may be provided with a pin P so that the covering shelf and the cargo screen are attached to a trunk T and removed therefrom when not needed and when mounted and used, rotate together when the trunk is opened, and the pin P is forcibly inserted into a support groove H formed on surfaces facing each other in the trunk T and is mounted to rotate in place.

### SUMMARY OF THE INVENTION

However, the hinge structure used in such an existing covering shelf or cargo screen has the following problems.
(1) Since a pin should be forcibly inserted into a support groove for assembly, it is difficult to assemble/remove the pin from the support groove when the covering shelf or cargo screen is mounted or removed when not in use.
(2) Therefore, there are times when the covering shelf or cargo screen is assembled in a state in which the pin does not correctly enter the support groove. In the covering shelf or cargo screen assembled as described above, there are times when the pin is separated or removed from the support groove due to vibration generated when the vehicle is traveling.
(3) This may cause the covering shelf or cargo screen to fall downward toward a trunk floor, and thus there is a risk that a stored item may be damaged, or the covering shelf or cargo screen may be damaged.

The present invention has been made in consideration of the above-mentioned problems, and is directed to providing a mounting hinge mounted on a covering shelf or cargo screen for vehicles, capable of maintaining an assembled state in which a hinge protrusion, which is elastically supported in a main body, is always in contact with a guide groove by configuring one side of the hinge protrusion to protrude out of the main body and configuring a protruding portion to be forcibly fitted into a guide groove formed in a trunk to assemble the covering shelf or cargo screen, thereby preventing detachment and separation of the covering shelf or cargo screen so that the covering shelf or cargo screen is safely and conveniently used.

In this case, the present invention is also directed to providing a mounting hinge mounted on a covering shelf or cargo screen for vehicles, capable of being stably, easily, and conveniently assembled/disassembled as a hinge protrusion moves by elastic support according to a shape of a guide groove on a center line of rotation of the covering shelf or cargo screen by configuring the hinge protrusion to protrude outward from the edge of the covering shelf or cargo screen.

Further, the present invention is also directed to providing a mounting hinge mounted on a covering shelf or cargo screen for vehicles, capable of preventing the covering shelf or cargo screen from being rotated or pulled too much by mounting two hinge protrusions on each of both edges of the covering shelf or cargo screen to allow the hinge protrusions to act as a stopper as well as performing a hinge function, thereby making it possible to use the covering shelf or cargo screen more conveniently or safely.

According to an aspect of the present invention, there is provided a mounting hinge mounted on a covering shelf or cargo screen for vehicles installed in a trunk (T) of a vehicle including a main body (110) including first and second main bodies (110a, 110b) configured to be coupled to face each other and having an operating space (111) formed therein, a hinge protrusion (120) configured to slide back and forth along a longitudinal direction of the operating space (111) in the operating space (111) and installed such that one side thereof protrudes outward through either one of the first and second main bodies (110a, 110b), and a spring (130) installed in the operating space (111) and configured to elastically support the hinge protrusion (120) so that the hinge protrusion (120) protrudes outward.

In particular, in the first and second main bodies (110a, 110b), a plurality of mounting protrusions (112) may be formed to protrude along an entire length of a surface in contact with a luggage board.

Finally, two mounting hinges may be installed on each of both edges of the covering shelf or cargo screen opposite each other so that the hinge protrusions (120) are positioned side by side, and the hinge protrusion (120) is configured to expand and contract in the longitudinal direction as the hinge protrusion (120) moves along a guide groove (G) formed in the trunk (T).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a rear perspective view of a vehicle showing a state in which a trunk is opened in a vehicle on which a covering shelf is mounted;

FIG. 2 is a perspective view of the inside of a trunk showing an example in which a covering shelf in the related art is installed between both sides constituting the trunk;

FIG. 3 is a front view of the inside of the trunk showing an example in which the covering shelf in the related art is installed between both sides constituting the trunk;

FIG. 4A is an image showing a part of an inner wall of a trunk in which a covering shelf in the related art is installed and FIG. 4B is an image showing the covering shelf;

FIG. 5 is an enlarged side view showing a state in which a covering shelf is pin-coupled to a support groove formed on a trunk surface;

FIG. 6 is a partial perspective view showing an example of a covering shelf on which mounting hinges according to the present invention are mounted;

FIG. 7 is a cross-sectional view showing an example of the covering shelf on which the mounting hinge according to the present invention is mounted;

FIG. 8 is an exploded perspective view for showing a configuration of the mounting hinge according to the present invention; and

FIG. 9 is an image showing a state in which the mounting hinge according to the present invention is mounted on a guide groove formed on an inner surface of a trunk.

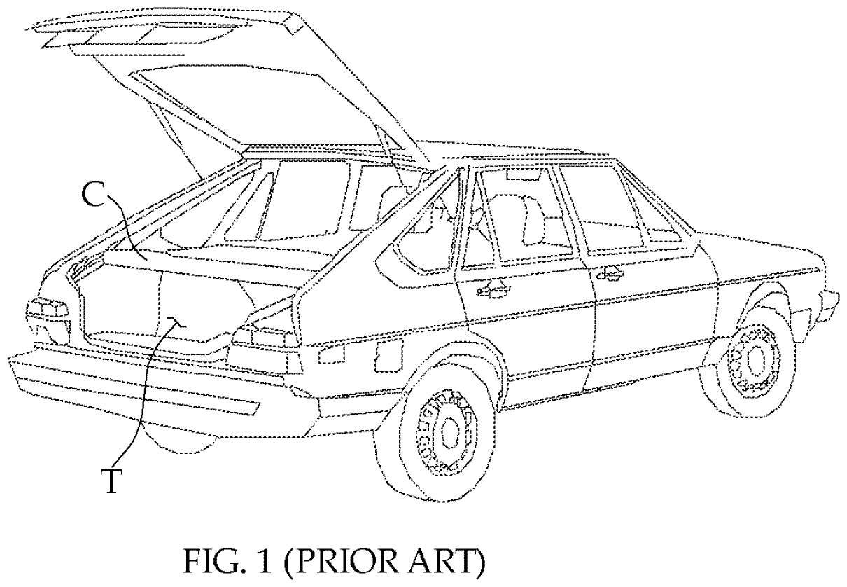

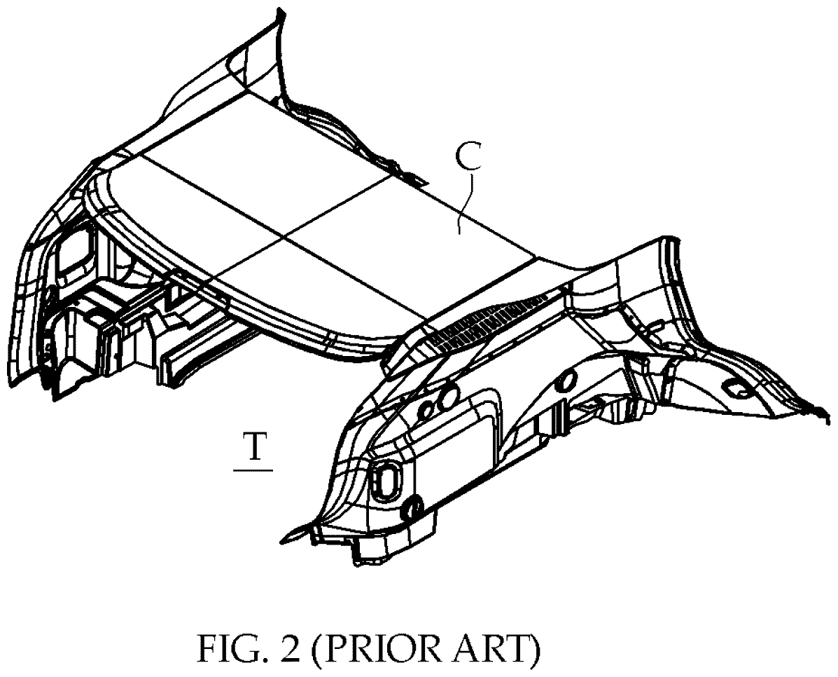

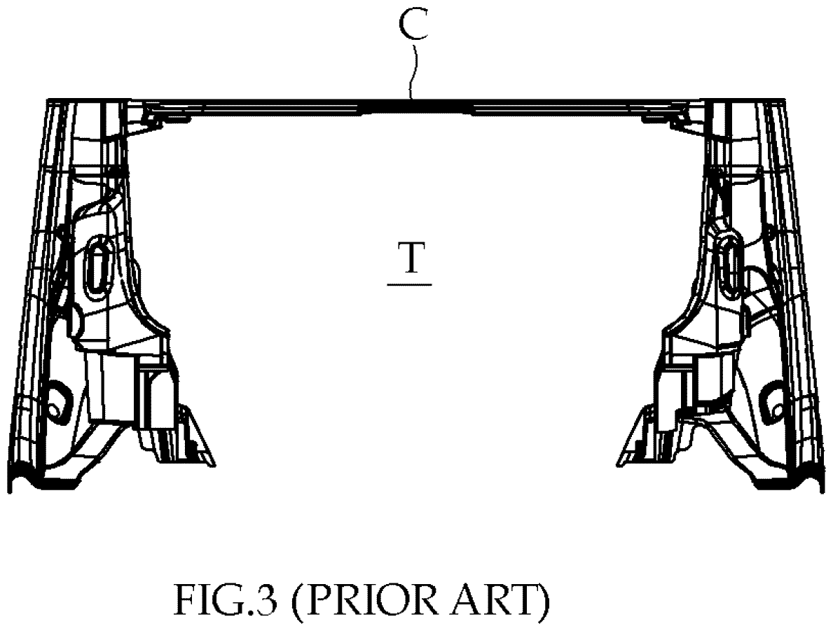

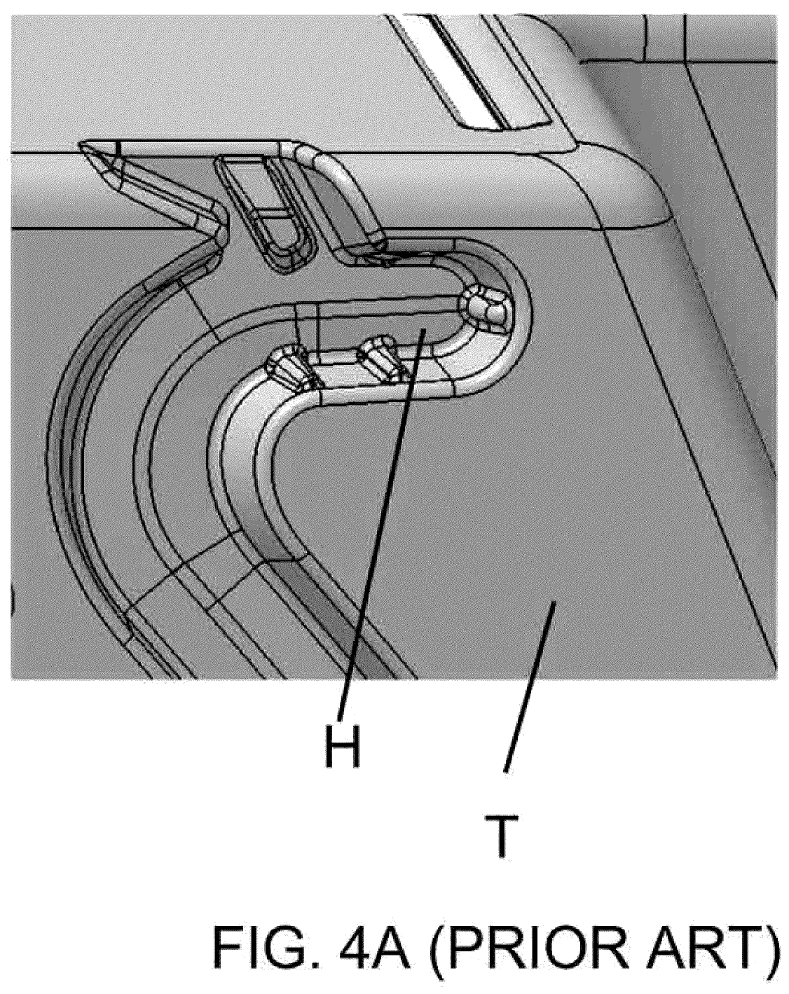

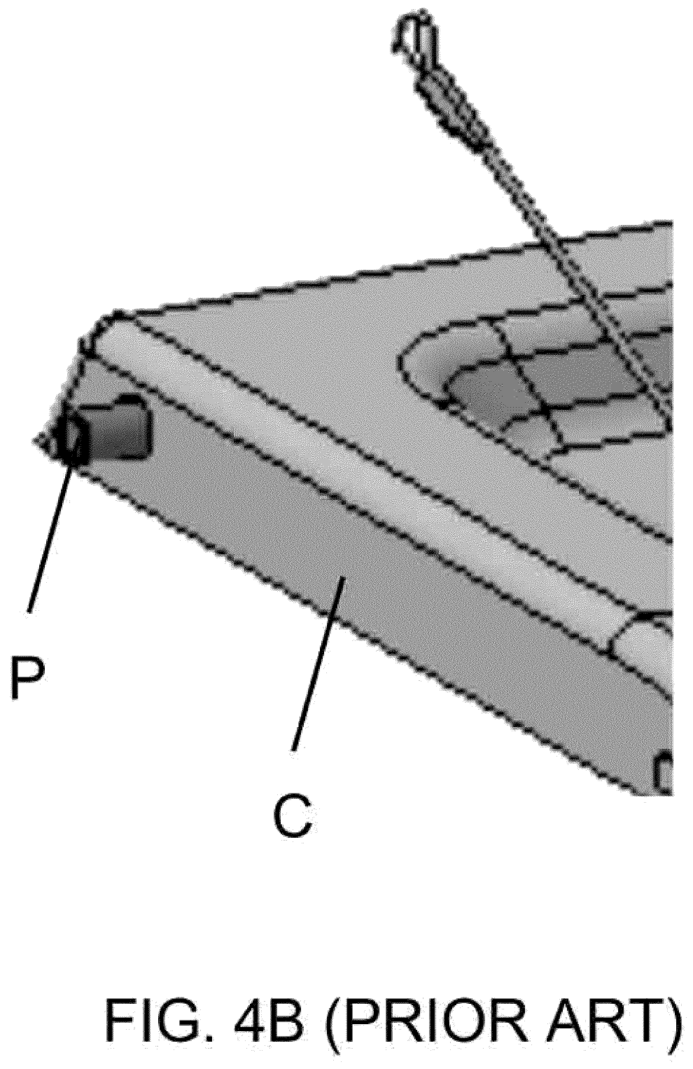

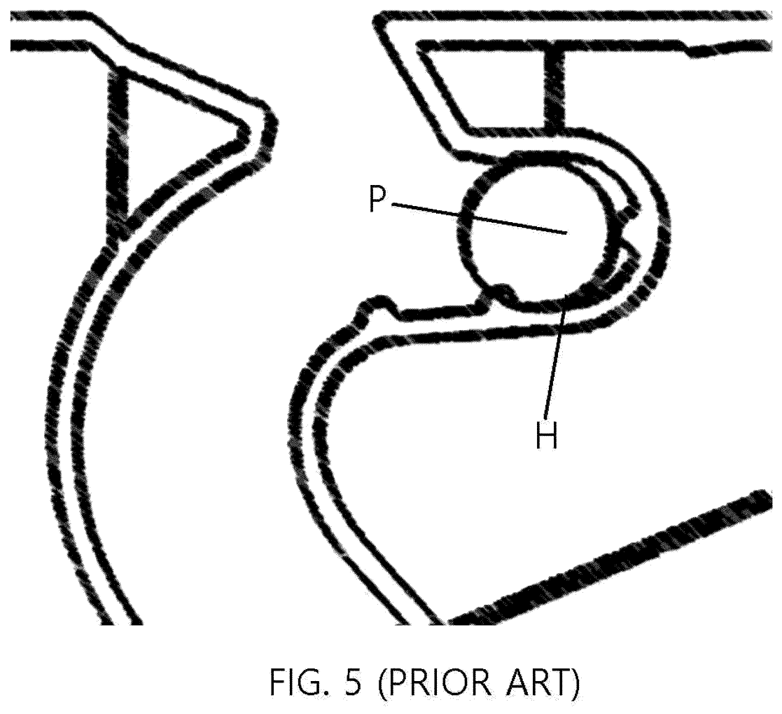

### DETAILED DESCRIPTION OF EXEMPLARY EMBODIMENTS

Hereinafter, preferred embodiments of the present invention will be described in more detail with reference to the accompanying drawings. Prior to the description, terms or words used in this specification and claims should not be restrictively interpreted as ordinary meanings or dictionary-based meanings, but should be interpreted as meanings and concepts conforming to the technical aspects of the present invention according to the principle that an inventor is allowed to properly define concepts of terms to describe his or her invention in the best ways.

Therefore, embodiments described in the specification and configurations shown in the drawings are merely the most preferred embodiment of the present invention, but are not intended to fully describe the technical aspects of the present invention, so it should be understood that a variety of other equivalents and modifications could be made thereto at the time of filing the application.

[Configuration of Mounting Hinge]

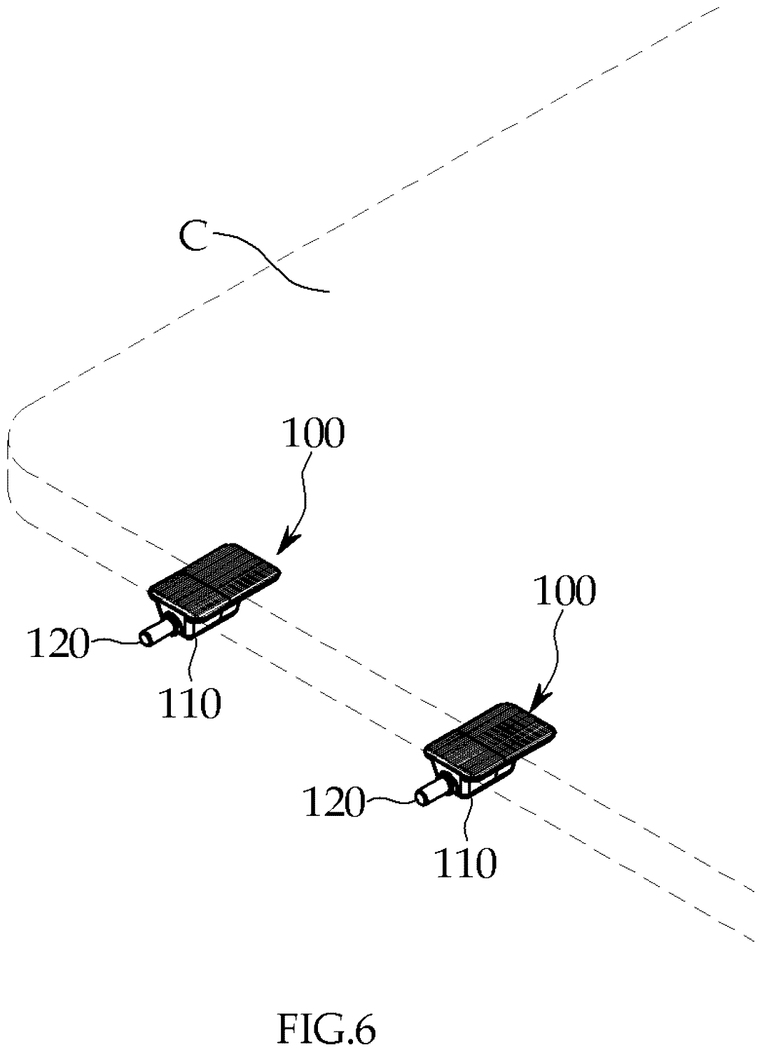

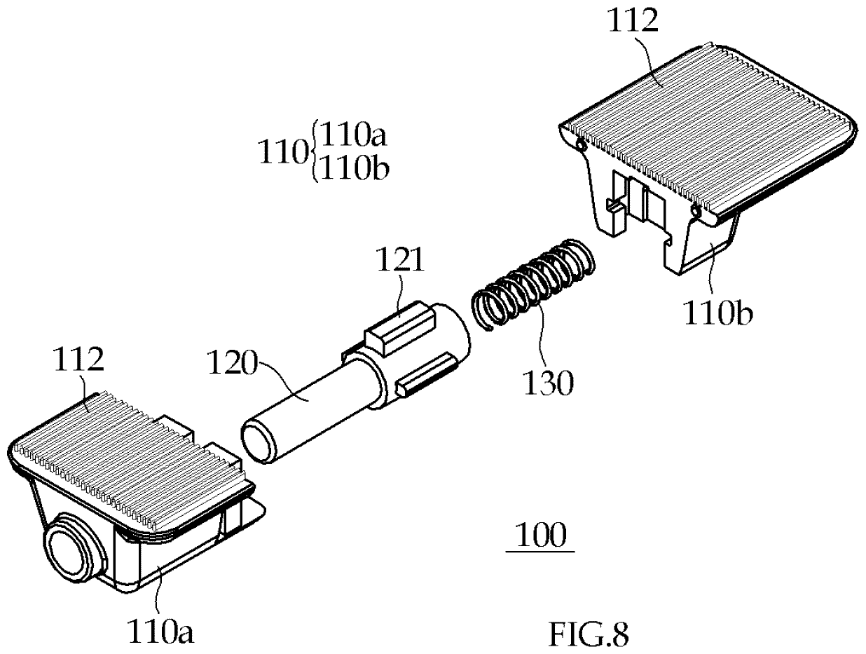

As shown in FIGS. 6 to 9, a mounting hinge 100 according to the present invention includes a main body 110 including first and second main bodies 110a and 110b, a hinge protrusion 120, and a spring 130 so that an operating space 111 is formed therein.

In particular, the hinge protrusion 120 has one side formed to protrude out of the main body 110 by being supported by the spring 130, and a protruding portion is configured to expand and contract in length according to a width and cross-sectional shape of a guide groove G formed in a trunk T, thereby easily mounting a covering shelf or cargo screen on the trunk and preventing the covering shelf or cargo screen from being separated or detached, so that the covering shelf or cargo screen may be safely used.

In addition, the main body 110 has a mounting protrusion 112 formed to protrude on a surface in contact with the covering shelf or cargo screen so that the covering shelf or cargo screen may be easily and conveniently assembled and used.

Further, two mounting hinges according to the present invention are installed on each of both edges of the covering shelf or cargo screen, so that one functions to rotate and the other is used as a stopper, or both are used as stoppers, and thus the covering shelf or cargo screen may be stably supported and fixed.

Hereinafter, such a configuration will be described in more detail with reference to the accompanying drawings. Here, the mounting hinge 100 according to the present invention may be used by being mounted on the covering shelf, the cargo screen, or the like, installed inside the trunk T, and here, for convenience of description, mounting on the covering shelf C will be described as an example.

A. Main Body

As shown in FIGS. 6 to 9, the main body 110 includes the first main body 110a and the second main body 110b, the first main body 110a and the second main body 110b are configured to be coupled to each other and assembled into one, and the operating space 111 is configured to mount other components to be described below therein.

Here, the first main body 110a and the second main body 110b are configured to be assembled into one using elasticity such as a snap fit or dove tail or assembled by a method such as adhesion, so that anyone may easily and conveniently assemble and use the main body.

In addition, as shown in FIGS. 6 to 8, on the main body 110, a mounting protrusion 112 is formed to protrude on a surface facing the covering shelf C. When the mounting protrusion 112 is mounted on the surface of the covering shelf C, the mounting protrusion 112 is fused to be attached integrally, or when the mounting protrusion 112 is attached to the covering shelf C, an adhesive or the like is used to increase an attachment effect.

Meanwhile, as shown in FIGS. 6 to 9, in the operating space 111 formed in this way, the hinge protrusion 120 and the spring 130 are mounted.

B. Hinge Protrusion

As shown in FIGS. 6 to 9, the hinge protrusion 120 is mounted so that one side is positioned in the above-described operating space 111 and the other side protrudes out of the main body 110. In the drawings, the hinge protrusion 120 is shown as an example configured to protrude out of the main body 110 through the first main body 110a.

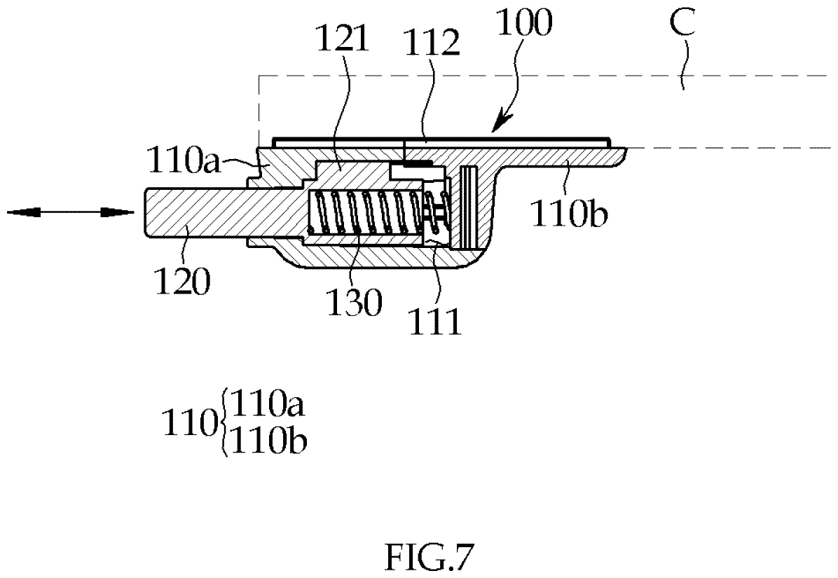

As shown in FIGS. 7 to 9, the hinge protrusion 120 is elastically supported by the spring 130 installed in the operating space 111. In addition, a raised portion 121 is formed on the sliding part in the operating space 111 so that the hinge protrusion 120 is not completely detached from the operating space 111 and expands and contracts within a predetermined distance.

C. Spring

As shown in FIGS. 7 to 9, the spring 130 is installed in the above-described operating space 111 and elastically supports the hinge protrusion 120 so that one side of the hinge protrusion 120 protrudes out of the main body 110. Accordingly, since the hinge protrusion 120 has one side that is always elastically supported and the one side protrudes out of the main body 110, not only the protruding portion may function as a pin, but also the protruding length of the hinge protrusion 120 protruding from the main body 110 may be adjusted as the hinge protrusion 120 moves in its longitudinal direction.

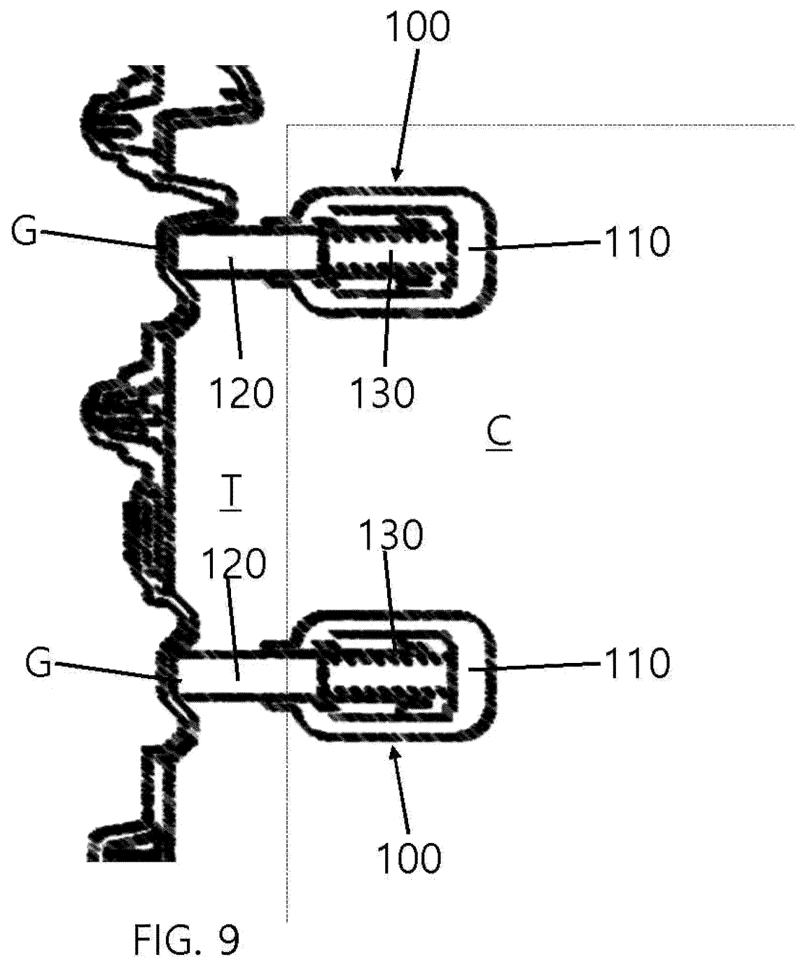

The mounting hinge 100 according to the present invention as described above may be used by being mounted on each of both sides of the covering shelf C or cargo screen, and two mounting hinges 100 may be used by being mounted on each of both edges of the covering shelf C or cargo screen as shown in FIG. 6 or 9. In this case, the mounting hinge 100 is installed in the guide groove G formed in the surfaces constituting the trunk T and installed to face each other, so that while the hinge protrusion 120 of the mounting hinge 100 is guided by the guide groove G, the length of the hinge protrusion 120 changes according to the depth of the guide groove G, and thus the covering shelf C or cargo screen may be easily and conveniently attached or detached.

A mounting hinge mounted on a covering shelf or cargo screen for vehicles according to the present invention has the following effects.
(1) Since mounting is performed as a hinge protrusion moves by elastic support of a spring along a longitudinal direction in accordance with a depth of a guide groove, a covering shelf or cargo screen can be stably supported.
(2) In particular, since the hinge protrusion always maintains a state of being in contact with the guide groove surface by the elastic support, the hinge protrusion can be prevented from being separated from or detached from the guide groove.
(3) Accordingly, the covering shelf or cargo screen installed in a trunk is prevented from falling on a trunk floor or hanging, and thus the covering shelf or cargo screen can be safely and conveniently used.
(4) In addition, since the length of the hinge protrusion is adjusted by the elastic support according to an inner shape of the guide groove for guiding the hinge protrusion, a stopper, protrusion, or groove is formed to protrude inside the guide groove, thereby easily and conveniently fixing the hinge protrusion in a fixed position, and thus the covering shelf or a cargo screen can be rotatably supported.
(5) Meanwhile, by installing two mounting hinges according to the present invention on each of both edges of the covering shelf or cargo screen, one of the mounting hinges functions as a hinge to support rotation while the other prevents the covering shelf or cargo screen from rotating too rapidly and functions as a stopper, and thus covering shelf or cargo screen can be more safely and conveniently used.

1. A mounting hinge mounted on a covering shelf or cargo screen for vehicles installed in a trunk (T) of a vehicle, the mounting hinge comprising:
a main body (110) including first and second main bodies (110a, 110b) configured to be coupled to face each other and having an operating space (111) formed therein;
a hinge protrusion (120) configured to slide back and forth along a longitudinal direction of the operating space (111) in the operating space (111) and installed so that one side thereof protrudes outward through either one of the first and second main bodies (110a, 110b); and
a spring (130) installed in the operating space (111) and configured to elastically support the hinge protrusion (120) so that the hinge protrusion (120) protrudes outward.

2. The mounting hinge of claim 1, wherein in the first and second main bodies (110a, 110b), a plurality of mounting protrusions 112 are formed to protrude along an entire length of a surface in contact with a luggage board.

3. The mounting hinge of claim 1, wherein two mounting hinges are installed on each of both edges of the covering shelf or cargo screen opposite each other so that the hinge protrusions (120) are positioned side by side, and the hinge protrusion (120) is configured to expand and contract in the longitudinal direction as the hinge protrusion (120) moves along a guide groove (G) formed in the trunk (T).

4. The mounting hinge of claim 2, wherein two mounting hinges are installed on each of both edges of the covering shelf or cargo screen opposite each other so that the hinge protrusions (120) are positioned side by side, and the hinge protrusion (120) is configured to expand and contract in the longitudinal direction as the hinge protrusion (120) moves along a guide groove (G) formed in the trunk (T).
